(19) United States
(12) Patent Application Publication
(10) Pub. No.: US 2025/0372793 A1
(43) Pub. Date: Dec. 4, 2025

(54) TRACTION BATTERY PACK MODULE ATTACHMENT SYSTEM HAVING CLEATS

(71) Applicant: Ford Global Technologies, LLC, Dearborn, MI (US)

(72) Inventors: Himanshu Khandelwal, Warren, MI (US); Ryan Scott Gray, JR., Farmington Hills, MI (US); Jamie Mink, Flat Rock, MI (US); Wendy Carek, Ferndale, MI (US); Thomas Edward Smith, Livonia, MI (US); Tamilvanan Arunachalam, Canton, MI (US)

(21) Appl. No.: 18/677,489

(22) Filed: May 29, 2024

(51) Int. Cl. H01M 50/262; B60L 50/60; H01M 50/209

(52) U.S. Cl. CPC H01M 50/262; H01M 50/209; B60L 50/60; H01M 2220/20

(57) ABSTRACT

A battery pack assembly includes a structural member of a battery pack; a module of the battery pack; and an attachment system having a plurality of cleats. The cleats can interlock to secure the module to the structural member. Mechanical fasteners can also be used to secure the module to the structural member.

### TECHNICAL FIELD

This disclosure relates generally to securing modules of a traction battery pack and, more particularly, to securing the modules through an attachment system with cleats.

### BACKGROUND

Electrified vehicles include a traction battery pack for powering electric machines and other electrical loads of the vehicle. The traction battery pack can include cell stacks having a plurality of battery cells. The traction battery pack can further include various other battery internal components that support electric vehicle propulsion.

### SUMMARY

In some aspects, the techniques described herein relate to a battery pack assembly, including: a structural member of a battery pack; a module of the battery pack; and an attachment system having a plurality of cleats that interlock to secure the module to the structural member.

In some aspects, the techniques described herein relate to a battery pack assembly, wherein the structural member is a cross-member within an enclosure of the battery pack.

In some aspects, the techniques described herein relate to a battery pack assembly, wherein the structural member is an extruded structural member.

In some aspects, the techniques described herein relate to a battery pack assembly, wherein at least one cleat in the plurality of cleats is an extruded cleat.

In some aspects, the techniques described herein relate to a battery pack assembly, wherein the attachment system secures the module to a forward facing side of the structural member within an interior of the battery pack.

In some aspects, the techniques described herein relate to a battery pack assembly, wherein the plurality of cleats includes at least one upper cleat of the module and a least one lower cleat of the structural member.

In some aspects, the techniques described herein relate to a battery pack assembly, wherein the plurality of cleats includes at least one upturned cleat of the module and at least one downturned cleat of the structural member.

In some aspects, the techniques described herein relate to a battery pack assembly, wherein the attachment system is a French cleat attachment system.

In some aspects, the techniques described herein relate to a battery pack assembly, further including at least one mechanical fastener that secures the module to the structural member.

In some aspects, the techniques described herein relate to a battery pack assembly, wherein the at least one mechanical fastener includes at least one clinch bolt.

In some aspects, the techniques described herein relate to a battery pack assembly, wherein the at least one mechanical fastener includes at least one rivet nut.

In some aspects, the techniques described herein relate to a battery pack assembly, wherein the plurality of cleats include a cleat on a bottom corner of the module, the at least one mechanical fastener securing an upper area of the module directly to the structural member.

In some aspects, the techniques described herein relate to a battery pack assembly, wherein the module is a battery energy control module.

In some aspects, the techniques described herein relate to a battery pack assembly, wherein the module is a bussed electrical center.

In some aspects, the techniques described herein relate to a battery pack assembly, wherein the module is a DC-DC converter.

In some aspects, the techniques described herein relate to a battery pack module securing method, including: interlocking a first cleat of a module of a battery pack with a second cleat of a structural member of the battery pack to secure the module to the structural member; and after the interlocking, additionally securing the module to the structural member with at least one mechanical fastener.

In some aspects, the techniques described herein relate to a battery pack module securing method, further including, after securing the module to the structural member, positioning the module and the structural member into an interior of a battery pack enclosure, and then securing the structural member within the battery pack enclosure.

In some aspects, the techniques described herein relate to a battery pack module securing method, further including rotating the module about the first cleat and the second cleat after the interlocking an prior to the securing.

In some aspects, the techniques described herein relate to a battery pack module securing method, wherein the first cleat extends along a bottom corner of the module.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack.

FIG. 2 illustrates a perspective view of the battery pack of FIG. 1 according to an exemplary aspect of the present disclosure.

FIG. 3 illustrates the battery pack of FIG. 2 with an enclosure cover removed to reveal battery pack modules and cell stacks within an interior of the battery pack.

FIG. 4 illustrates a close-up view of a portion of FIG. 3 showing battery pack modules within an interior of the battery pack.

FIG. 5 illustrates a section view taken at line 5-5 in FIG. 4 and showing a battery pack module in broken lines moving to an installed position and the battery pack module in an installed position where a cleat of the battery pack module is interlocked with a cleat of a structural member.

FIG. 6 illustrates a perspective view of a structural member for use in the battery pack of FIGS. 2 and 3 according to another exemplary aspect of the present disclosure.

FIG. 7 illustrates a rear view of the structural member of FIG. 6.

FIG. 8 illustrates a front view of the structural member of FIG. 6 with a plurality of modules secured to the structural member.

### DETAILED DESCRIPTION

This disclosure details exemplary systems and methods for attaching battery pack modules to a structural member of a battery pack. The attachment systems and methods utilize cleats that interlock. These and other features are discussed in greater detail in the following paragraphs.

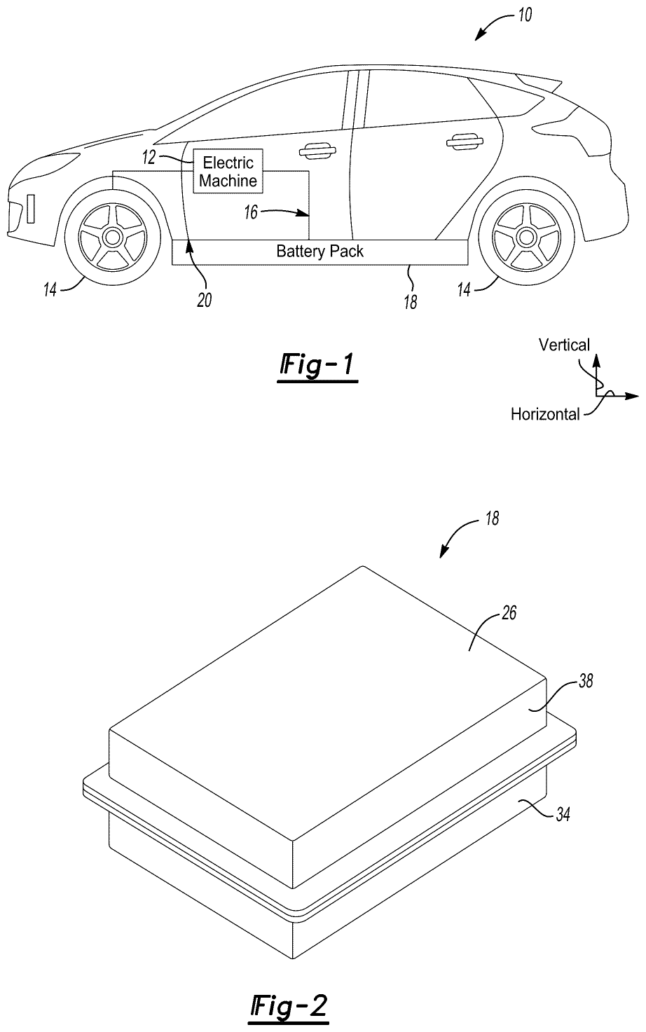

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEVs), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 electrically couples the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 is secured to an underbody 20 of the electrified vehicle 10. However, the traction battery pack 18 could be located elsewhere on the electrified vehicle 10 in other examples.

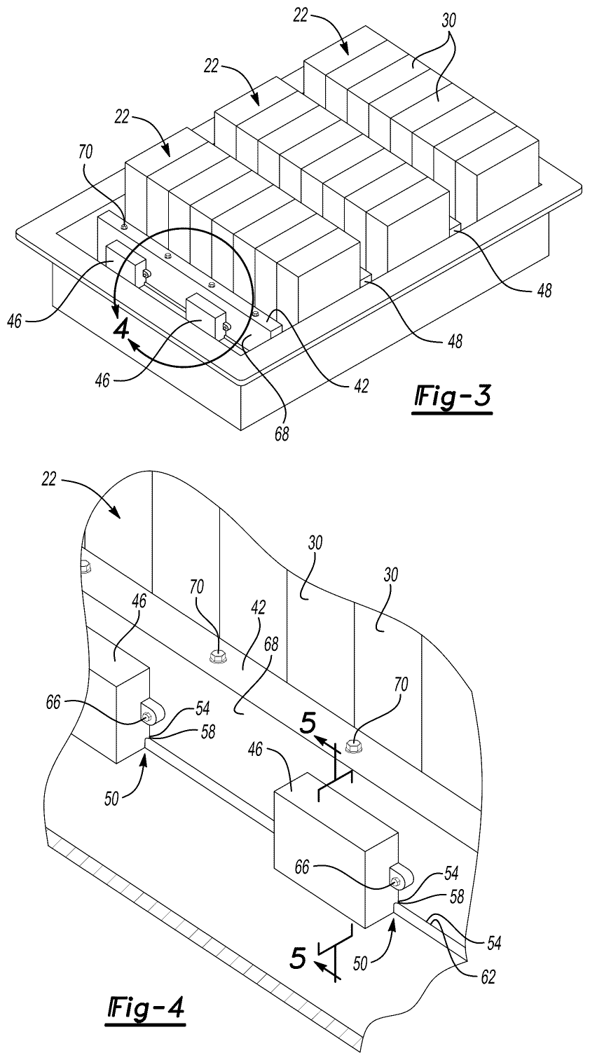

With reference to FIGS. 2-5, in an exemplary embodiment of the present disclosure, the traction battery pack 18 includes a plurality of cell stacks 22 housed within an interior of an enclosure assembly 26. The cell stacks 22 are arranged on multiple tiers within an interior of the enclosure assembly 26. Three of the cell stacks 22 are arranged on a upper tier within the interior. Three of the cell stacks 22 are arranged on a lower tier within the interior. Each cell stack 22 includes a plurality of individual battery cells 30 stacked side-by-side relative to one another along a cell stack axis. The cells 30 are lithium-ion, prismatic battery cells in this example. However, battery cells having other geometries (cylindrical, pouch, etc.) and/or chemistries (nickel-metal hydride, lead-acid, etc.) could alternative be utilized within the scope of this disclosure.

The enclosure assembly 26 includes an enclosure tray 34 and an enclosure cover 38 that provide the interior. Disposed within the interior along with the cell stacks 22 are, in this example, a structural member 42 and various battery pack modules 46 secured to the structural member 42. Other structural members 48 are also disposed within the interior. The structural member 42 and the structural members 48 can be extruded.

An attachment system 50 is used to secure the battery pack modules 46 to the structural member 42. The attachment system 50 includes a plurality of cleats 54 that interlock to secure the associated battery pack module 46 to the structural member 42. The plurality of cleats 54 include at least one upper cleat 58, which is part of one of the battery pack modules 46, and at least one lower cleat 62 which is part of the structural member 42. The lower cleat 62 is an upturned cleat. The upper cleat 58 is a downturned cleat. The lower cleat 62 extends along a bottom forward edge of the structural member 42. The lower cleat 62 is on a rear corner of the associated battery pack module 46.

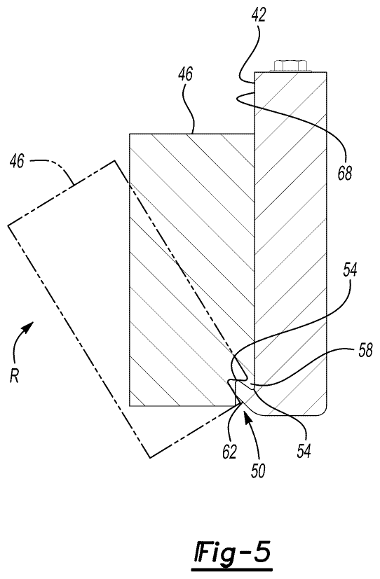

In this example, the upper cleat 58 and lower cleat 62 are characterized as a French cleat attachment system. Installing the battery pack modules 46 to the structural member 42 includes, in this example, first inserting the lower cleat 62 into the upper cleat 58 such that the lower cleat 62 and the upper cleat 58 are interlocked as shown in broken lines in FIG. 5.

Next, the module 46 is rotated about the upper cleat 58 and the lower cleat 62 in a direction R from the broken line position in FIG. 5 to the installed position shown in FIG. 5 where the module 46 is in contact with the structural member 42. The module 46 could, instead of rotating about the upper cleat 58 and the lower cleat 62, slide vertically downward to interlock the upper cleat 58 with the lower cleat 62.

Next, a plurality of mechanical fasteners 66 are used to secure the module 46 to the structural member 42. The fasteners 66 prevent rotation of the module 46 away from the structural member 42 in a direction opposite the direction R. The mechanical fasteners 66 can be threaded mechanical fasteners, such as clinch bolts, rivet nuts, etc.

Interlocking the upper cleat 58 and the lower cleat 62 secures the lower portions of the module 46 to the structural member 42. Thus, mechanical fasteners 66 are not needed in this area and can instead be used to secure an upper area of the modules 46 to the structural member 42. Interlocking the upper cleat 58 and the lower cleat 62 to secure a bottom corner of the module 46 to the structural member 42 can thus reduce a number of required mechanical fasteners and labor time associated with engaging mechanical fasteners to secure a module to a structural member.

Relative to a general orientation of the vehicle 10 in FIG. 1, the battery pack modules 46 in the example embodiment are secured to a forward facing side 68 of the structural member 42. The battery pack modules 46 can be secured to other sides of the structural member 42 in other examples.

In this example, the structural member 42 extends longitudinally in a cross-vehicle direction and functions as a cross-member for the battery pack 18. The structural member 42 can be secured to the enclosure tray 34, a lower cross-member, or another structure via a plurality of other mechanical fasteners 70, which can be threaded bolts.

In an example, the battery pack modules 46 are secured to the structural member 42 through the mechanical fasteners 66 and the interlocking of the upper cleat 58 with the lower cleat 62 prior to the mechanical fasteners 70 being used to install the structural member 42 and the battery pack modules 46 within the enclosure tray 34. For example, after securing the battery pack modules 46 to the structural member 42, the battery pack modules 46 and the structural member 42 can be placed into the enclosure tray 34. The structural member 42 is then anchored within the enclosure tray 34 through the mechanical fasteners 70.

In some examples, one or more thermal interface pads can be attached to the battery pack modules 46 and/or the structural member 42 such that the thermal interface pads are sandwiched between the battery pack modules 46 and structural member 42 when the battery pack modules 46 are secured to the structural member 42. The thermal interface pads can help to communicate thermal energy between the battery pack modules 46 and the structural member 42. The structural member 42 can, for example, provide a heat sink for the battery pack modules 46.

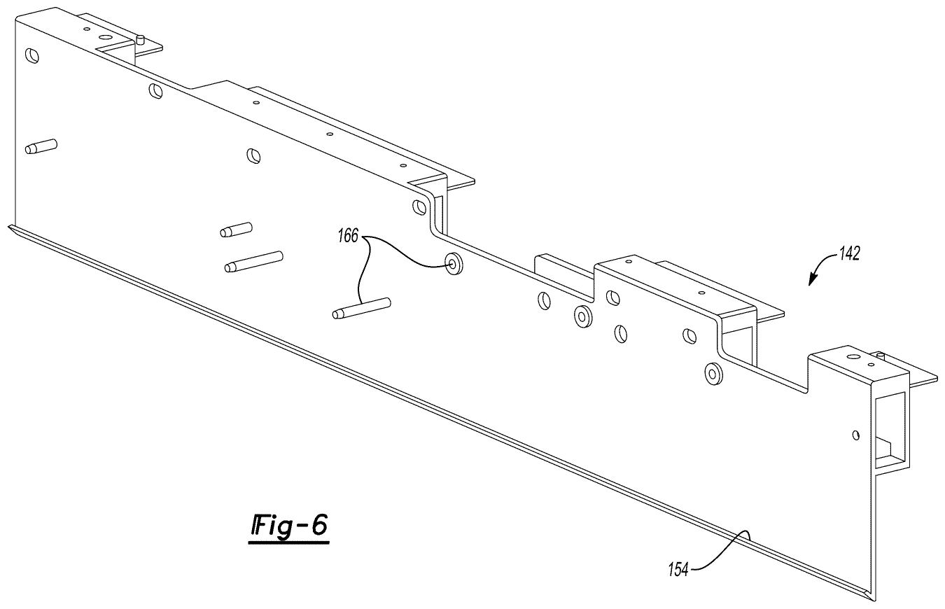

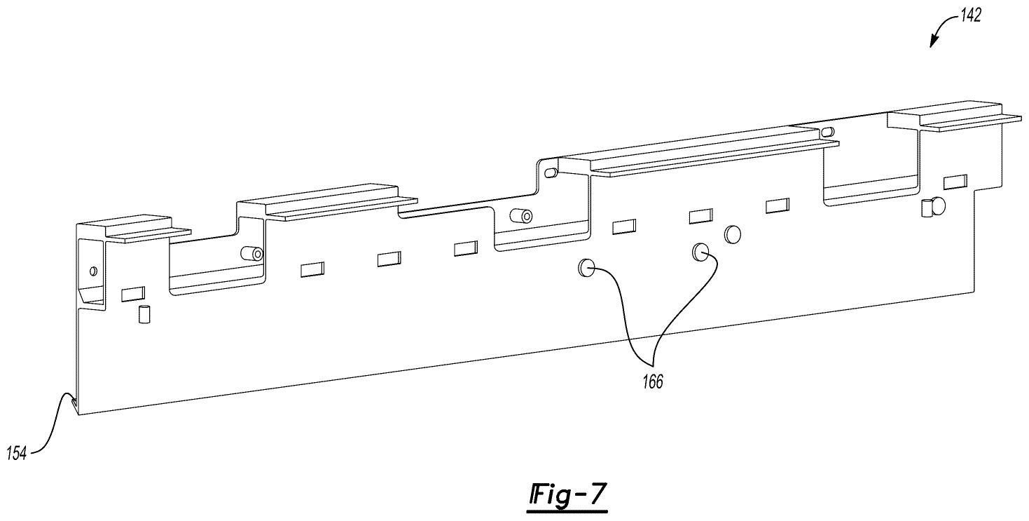

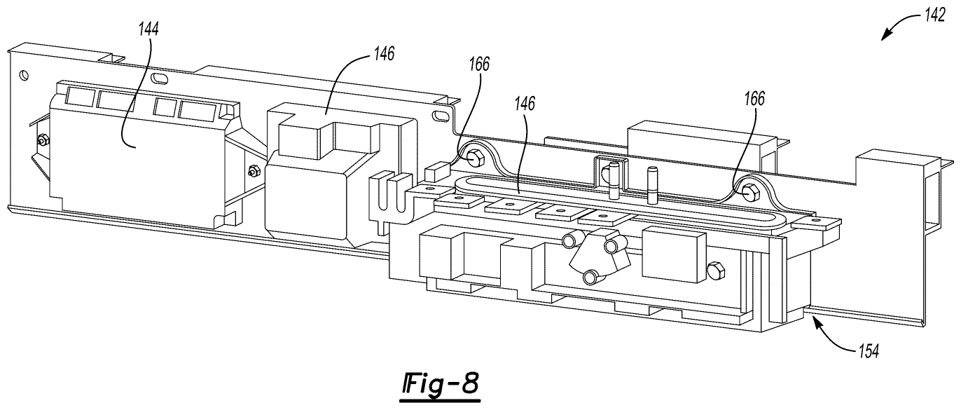

With reference now to FIGS. 6-8, another example structural member 142 is an extruded structural member. The structural member 142 can be extruded aluminum. A person having skill in this art and the benefit of this disclosure would be able to distinguish a structure that is extruded from a structure that is not extruded. Thus, characterizing the structural member 142 as an extruded structural member implicates structure to the structural member 42.

Modules 146 are secured to a forward facing side of the structural member 142 through, among other things, a plurality of cleats 154. Cleats of the battery pack modules 146 interlock with cleats of the structural member 142 to secure the modules 146 to the structural member 142. mechanical fasteners 166 can be used to secure the modules 146 and to block the cleats from unlocking.

The battery pack modules 146, and the battery pack modules 46 of the embodiment of FIGS. 2-5, include a wide variety of types of battery pack modules. In this example, the modules 146 include a battery energy control module (BECM), a bussed electrical center (BEC), and a DC-DC converter. Other types of modules 146 could be secured to the structural member 142 in other examples.

Like the structural member 42 and the modules 46, the modules 146 can be secured to the structural member 142, and the structural member 142 with the modules 146 then positioned within an enclosure tray. The structural member 142 can then be secured to the enclosure tray through a plurality of mechanical fasteners after the modules 146 have already been attached.

Features of the disclosed examples includes using a cleat-based attachment system to help secure modules to a structural member, which can help to reduce complexity.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack assembly, comprising:
a structural member of a battery pack;
a module of the battery pack; and
an attachment system having a plurality of cleats that interlock to secure the module to the structural member.

2. The battery pack assembly of claim 1, wherein the structural member is a cross-member within an enclosure of the battery pack.

3. The battery pack assembly of claim 1, wherein the structural member is an extruded structural member.

4. The battery pack assembly of claim 1, wherein at least one cleat in the plurality of cleats is an extruded cleat.

5. The battery pack assembly of claim 1, wherein the attachment system secures the module to a forward facing side of the structural member within an interior of the battery pack.

6. The battery pack assembly of claim 1, wherein the plurality of cleats includes at least one upper cleat of the module and a least one lower cleat of the structural member.

7. The battery pack assembly of claim 1, wherein the plurality of cleats includes at least one upturned cleat of the module and a least one downturned cleat of the structural member.

8. The battery pack assembly of claim 1, wherein the attachment system is a French cleat attachment system.

9. The battery pack assembly of claim 1, further comprising at least one mechanical fastener that secures the module to the structural member.

10. The battery pack assembly of claim 9, wherein the at least one mechanical fastener comprises at least one clinch bolt.

11. The battery pack assembly of claim 9, wherein the at least one mechanical fastener comprises at least one rivet nut.

12. The battery pack assembly of claim 9, wherein the plurality of cleats include a cleat on a bottom corner of the module, the at least one mechanical fastener securing an upper area of the module directly to the structural member.

13. The battery pack assembly of claim 1, wherein the module is a battery energy control module.

14. The battery pack assembly of claim 1, wherein the module is a bussed electrical center.

15. The battery pack assembly of claim 1, wherein the module is a DC-DC converter.

16. A battery pack module securing method, comprising:
interlocking a first cleat of a module of a battery pack with a second cleat of a structural member of the battery pack to secure the module to the structural member; and
after the interlocking, additionally securing the module to the structural member with at least one mechanical fastener.

17. The battery pack module securing method of claim 16, further comprising, after securing the module to the structural member, positioning the module and the structural member into an interior of a battery pack enclosure, and then securing the structural member within the battery pack enclosure.

18. The battery pack module securing method of claim 17, further comprising rotating the module about the first cleat and the second cleat after the interlocking an prior to the securing.

19. The battery pack module securing method of claim 16, wherein the first cleat extends along a bottom corner of the module.
